(19) United States
(12) Patent Application Publication
(10) Pub. No.: US 2017/0247291 A1
(43) Pub. Date: Aug. 31, 2017

(54) CHEMICALLY STRENGTHENED GLASS

(71) Applicant: ASAHI GLASS COMPANY, LIMITED, Chiyoda-ku (JP)

(72) Inventors: Maya HATANO, Tokyo (JP); Koji NAKAGAWA, Tokyo (JP)

(73) Assignee: ASAHI GLASS COMPANY, LIMITED, Chiyoda-ku (JP)

(21) Appl. No.: 15/374,149

(22) Filed: Dec. 9, 2016

(30) Foreign Application Priority Data
Feb. 25, 2016 (JP) 2016-034478

(51) Int. Cl. C03C 21/00; C03C 3/085; C03C 4/18; C03C 3/087

(52) U.S. Cl. CPC C03C 21/002; C03C 3/087; C03C 3/085; C03C 4/18; C03C 2204/00

(57) ABSTRACT

The present invention provides a chemically strengthened glass suitable for use in applications in which the chemically strengthened glass is desired to have chemically strengthened properties that differ from surface to surface. The present invention relates to a chemically strengthened glass having a first surface and a second surface which faces the first surface, in which the first surface has a depth of compressive stress layer DOL₁ (μm) which is larger by at least 3 μm than a depth of compressive stress layer DOL₂ (μm) of the second surface, the second surface has a surface compressive stress CS₂ (MPa) which is higher by at least 50 MPa than a surface compressive stress CS₁ (MPa) of the first surface, and the chemically strengthened glass satisfies the following relational expressions (2) and (3):

[Dh(E)−Dh(1)]<0 (2)

[Dh(E)−Dh(2)]>0 (3).

### FIELD OF THE INVENTION

The present invention relates to a chemically strengthened glass.

### BACKGROUND OF THE INVENTION

In recent years, chemically strengthened glasses are used as, for example, the cover glasses of personal digital assistants such as cell phones and smartphones and of display devices, e.g., those of TVs, personal computers, and touch panels (see Patent Document 1, etc.).

As described in Patent Document 1, a chemical strengthening treatment of a glass is usually conducted by immersing the glass substrate in a melt of a metal salt (e.g., potassium nitrate) containing metal ions (e.g., K ions) having a large ionic radius to replace metal ions (e.g., Na ions or Li ions) having a small ionic radius and contained in the glass substrate with ions of the metal having a large ionic radius to thereby form a compressive layer in the glass substrate surfaces.

Meanwhile, Patent Document 2 discloses a cover glass which can retain strength even when flaws having a depth exceeding a given depth have formed therein. This cover glass includes a front-surface-side compressive stress layer formed on the front surface side that is exposed when the cover glass is in the state of having been attached to a member and a back-surface-side compressive stress layer formed on the back surface side, which is the side opposite to the front surface, in which the front-surface-side compressive stress layer has a depth larger than the depth of the back-surface-side compressive stress layer, and the back-surface-side compressive stress layer has been formed so that the surface stress value as measured on the back surface side has a peak value approximately at the depth of the compressive stress layer.

Patent Document 1: JP-A-2013-028506

Patent Document 2: WO 2013/088988

### SUMMARY OF THE INVENTION

In FIG. 1 is shown a stress profile of a conventional chemically strengthened glass which has undergone a chemical strengthening treatment such as that described in Patent Document 1. As shown in FIG. 1, such a chemically strengthened glass has a stress profile which is symmetrical along the thickness direction. In this stress profile, the compressive stress is maximum at the first and second surfaces, which are outermost surfaces of the glass. Here, the compressive stress at each outermost surface of the glass is referred to as surface compressive stress (CS). The compressive stress gradually decreases from the glass surface toward an inner part of the glass and becomes 0 at a certain depth (depth of compressive stress layer, DOL; unit, mm). In the part of the glass which lies deeper than the depth of compressive stress layer (DOL; unit, mm), tensile stress generates so that the integral of stress along the glass thickness direction becomes 0. This tensile stress is referred to as internal tensile stress (central tension, CT). In this case, the surface compressive stress (CS; unit, MPa), depth of compressive stress layer (DOL; unit, mm), and internal tensile stress (CT; unit, MPa) are generally represented by the following relational expression, where t (unit, mm) is the thickness of the glass.

CT [MPa]=(CS [MPa])×(DOL [mm])/[(t [mm])−2×(DOL [mm])]

It is generally known that the higher the CS of a chemically strengthened glass, the more the chemically strengthened glass withstands tension. It is also known that the larger the DOL and the lower the CT, the more the chemically strengthened glass withstands flaws and the less the glass is apt to fracture. However, as shown by the above relational expression, there is a trade-off relationship among those requirements, and it has been impossible to simultaneously satisfy all of those requirements.

Meanwhile, there are cases where chemically strengthened glasses are used as, for example, the cover glasses of display devices. In such cases, only one of the surfaces of the cover glass is exposed to the outside. In such a cover glass, there is a possibility that various substances might collide against the surface on the exposed side (exposed surface) to damage the glass. For example, in case where a colliding substance in which the colliding portion has a relatively large angle, e.g., a spherical colliding substance, collides against the exposed surface of the cover glass, then this cover glass is bent, and the surface (back surface) of the cover glass which is on the reverse side from the collision surface and the edge surfaces of the cover glass receive an external force (tensile stress) due to the bending. It is hence desirable that the CS of the back surface of the cover glass and the CS of the edge surfaces of the cover glass should be higher so that the cover glass resists the external force due to the bending. Meanwhile, there are cases where a colliding substance in which the colliding portion has a relatively small angle, e.g., a colliding substance having a sharp end, collides against the exposed surface of the cover glass to form a flaw in the exposed surface of the cover glass. In case where the flaw extends deeper than the compressive stress layer and the internal tensile stress is high, this cover glass cracks. Consequently, from the standpoint that a cover glass has flaw resistance, it is desirable that the DOL of the exposed surface of the cover glass should be larger and the CT thereof should be lower. Namely, in applications such as the cover glasses of display devices, the chemically strengthened properties which the chemically strengthened glass is desired to have differ from surface to surface.

In the case where the edge surfaces of the cover glass are exposed, there is a possibility that the edge surfaces might suffer a flaw when the display device is dropped and collides against something. It is hence desirable that the DOL of the edge surfaces of the cover glass should be larger.

However, in the cover glass obtained using a chemically strengthened glass having a stress profile which is symmetrical along the thickness direction, such as that shown in FIG. 1, the CS of the exposed surface is equal to the CS of the back surface and the DOL of the exposed surface is equal to the DOL of the back surface. Consequently, in cases when the CS of the back surface is further increased, the CS of the exposed surface also increases, and in cases when the DOL of the exposed surface is further increased, the DOL of the back surface also increases. As a result, both surfaces increase in CS and DOL. As shown by the relational expression, however, increasing the CS and DOL of both surfaces inevitably results in an increase in CT and the glass undesirably becomes prone to fracture.

Namely, the conventional chemically strengthened glass having a stress profile which is symmetrical along the thickness direction has been not always suitable for cases where the front and back surfaces are required to differ in chemically strengthened property and the edge surfaces also are required to have chemically strengthened properties, not only in cover glasses but also in other various applications.

In Patent Document 2, a cover glass is described in which the front-surface-side compressive stress layer has a larger depth than the back-surface-side compressive stress layer. However, Patent Document 2 contains no statement at all concerning any relationship between front-surface-side surface compressive stress and back-surface-side surface compressive stress. Furthermore, there is no mention therein of any chemically strengthened properties required for the edge surfaces of a cover glass.

Accordingly, an object of the present invention is to provide a chemically strengthened glass suitable for use in applications in which the chemically strengthened glass is desired to have chemically strengthened properties that differ from surface to surface and the edge surfaces also have the desired chemically strengthened properties so that not only cracks occurring in the main surface but also cracks starting from the edge surfaces can be inhibited, and in which chemically strengthened properties that are highly effective against various causes of cracking are desired.

The present inventors diligently made investigations in view of the conventional problems and, as a result, have found that the problems can be overcome with the chemically strengthened glass described below. The present invention has been thus completed.

Specifically, the chemically strengthened glass of the invention is a chemically strengthened glass having a first surface and a second surface which faces the first surface, in which the first surface has a depth of compressive stress layer DOL₁ (μm) which is larger by at least 3 μm than a depth of compressive stress layer DOL₂ (μm) of the second surface, the second surface has a surface compressive stress CS₂ (MPa) which is higher by at least 50 MPa than a surface compressive stress CS₁ (MPa) of the first surface, and the chemically strengthened glass satisfies the following relational expressions (2) and (3):

[Dh(E)−Dh(1)]<0 (2)

[Dh(E)−Dh(2)]>0 (3)

in which Dh(E) is the depth at which, when an edge surface of the chemically strengthened glass is examined with an EPMA (electron probe micro analyzer), the integral of replacing-ion X-ray intensity from the outermost surface of the edge surface becomes S(E)/2, where S(E) is the integral of replacing-ion X-ray intensity from the outermost surface of the edge surface to a depth of 80 μm,

Dh(1) is the depth at which, when the first surface of the chemically strengthened glass is examined with an EPMA, the integral of replacing-ion X-ray intensity from the outermost surface of the first surface becomes S(1)/2, where S(1) is the integral of replacing-ion X-ray intensity from the outermost surface of the first surface to a depth of 80 μm, and

Dh(2) is the depth at which, when the second surface of the chemically strengthened glass is examined with an EPMA, the integral of replacing-ion X-ray intensity from the outermost surface of the second surface becomes S(2)/2, where S(2) is the integral of replacing-ion X-ray intensity from the outermost surface of the second surface to a depth of 80 μm.

It is preferable that the chemically strengthened glass of the present invention satisfies the following relational expression (1):

(CS₁−CS₂)×(DOL₁−DOL₂)<−1,500 (1).

In the chemically strengthened glass of the present invention, it is preferable that the depth of compressive stress layer DOL₁ (μm) of the first surface is 15 μm or larger.

In the chemically strengthened glass of the present invention, it is preferable that the surface compressive stress CS₁ (MPa) of the first surface is 100 MPa or higher.

In the chemically strengthened glass of the present invention, it is preferable that the depth of compressive stress layer DOL₂ (μm) of the second surface is 5 μm or larger.

In the chemically strengthened glass of the present invention, it is preferable that the surface compressive stress CS₂ (MPa) of the second surface is 500 MPa or higher.

The chemically strengthened glass of the present invention may have a radius of curvature of 15,000 mm or larger, or the chemically strengthened glass of the present invention may have a radius of curvature of less than 15,000 mm.

Furthermore, the chemically strengthened glass of the present invention may be one obtained by chemically strengthening a curved-surface glass substrate.

The chemically strengthened glass of the present invention has a stress profile which is asymmetrical along the thickness direction, i.e., a stress profile in which the first surface has a depth of compressive stress layer DOL₁ which is larger by at least 3 μm than a depth of compressive stress layer DOL₂ of the second surface and the second surface has a surface compressive stress CS₂ which is higher by at least 50 MPa than a surface compressive stress CS₁ of the first surface. Therefore, the chemically strengthened glass of the present invention has a low internal tensile stress CT. CT of the chemically strengthened glass which has an asymmetrical stress profile is defined as follows:

CT=(CS₁ [MPa]×DOL₁ [mm]+CS₂ [MPa]×DOL₂ [mm])/2(t [mm]−(DOL₁ [mm]+DOL₂ [mm])).

Furthermore, the edge surfaces of the chemically strengthened glass of the present invention have a stress profile having a high CS and a large DOL. Consequently, it has become possible to inhibit not only cracks starting in the first or second main surface but also cracks starting from any of the edge surfaces. Namely, this chemically strengthened glass is one in which the front surface and the back surface have different chemically strengthened properties and the edge surfaces also have the desired chemically strengthened properties, when used in various applications including the cover glasses of display devices. Consequently, the chemically strengthened glass of the present invention can satisfy the desired properties even in applications where the desired chemically strengthened properties differ between the surfaces of the glass. The chemically strengthened glass of the present invention can have enhanced strength effective against various causes of cracks.

### BRIEF DESCRIPTION OF THE DRAWING

FIG. 1 is a drawing which shows a stress profile of a conventional chemically strengthened glass.

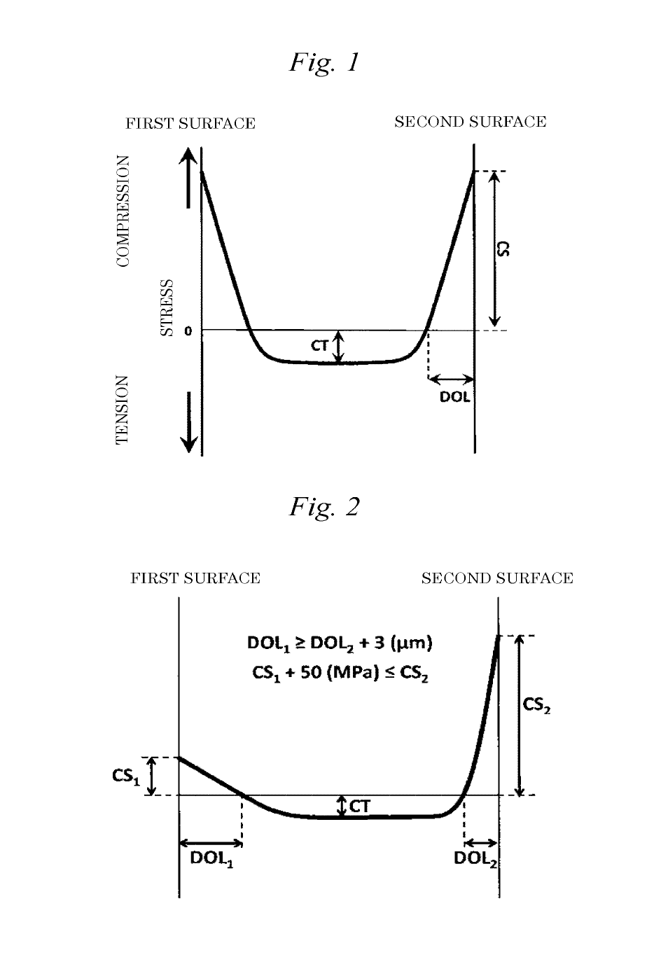

FIG. 2 is a drawing which shows a stress profile of a chemically strengthened glass according to one embodiment of the present invention.

(a) and (b) in FIG. 3 are drawings which show stress profiles obtained in the case where a glass substrate was immersed in a melt of a metal salt (molten salt) containing K ions to conduct a chemical strengthening treatment and the glass substrate was then taken out from the molten salt and placed at a high temperature.

(a) to (c) in FIG. 4 are explanatory drawings which show a method for chemical strengthening treatment according to one embodiment of the present invention.

FIG. 5 is a view for explaining a measuring portion at which a warpage amount is measured.

FIG. 6 is a drawing which shows the results of a measurement in which the first surface, the second surface, and an edge surface of a chemically strengthened glass according to one embodiment of the present invention were examined for replacing-ion X-ray intensity with an EPMA.

FIG. 7 is a thickness-direction cross-sectional view which illustrates one example of a glass substrate according to one embodiment of the present invention, the glass substrate having a peripheral edge part having a curved surface shape.

### DETAILED DESCRIPTION OF THE INVENTION

Embodiments of the present invention are explained below in detail.

The chemically strengthened glass of the present invention is a chemically strengthened glass having a first surface and a second surface which faces the first surface, in which the first surface has a depth of (compressive) stress layer DOL₁ which is larger by at least 3 μm than a depth of (compressive) stress layer DOL₂ of the second surface, the second surface has a surface compressive stress CS₂ which is higher by at least 50 MPa than a surface compressive stress CS₁ of the first surface, and the chemically strengthened glass satisfies the following relational expressions (2) and (3):

[Dh(E)−Dh(1)]<0 (2)

[Dh(E)−Dh(2)]>0 (3)

in which Dh(E) is the depth at which, when an edge surface of the chemically strengthened glass is examined with an EPMA, the integral of replacing-ion X-ray intensity from the outermost surface of the edge surface becomes S(E)/2, where S(E) is the integral of replacing-ion X-ray intensity from the outermost surface of the edge surface to a depth of 80 μm,

Dh(1) is the depth at which, when the first surface of the chemically strengthened glass is examined with an EPMA, the integral of replacing-ion X-ray intensity from the outermost surface of the first surface becomes S(1)/2, where S(1) is the integral of replacing-ion X-ray intensity from the outermost surface of the first surface to a depth of 80 μm, and

Dh(2) is the depth at which, when the second surface of the chemically strengthened glass is examined with an EPMA, the integral of replacing-ion X-ray intensity from the outermost surface of the second surface becomes S(2)/2, where S(2) is the integral of replacing-ion X-ray intensity from the outermost surface of the second surface to a depth of 80 μm.

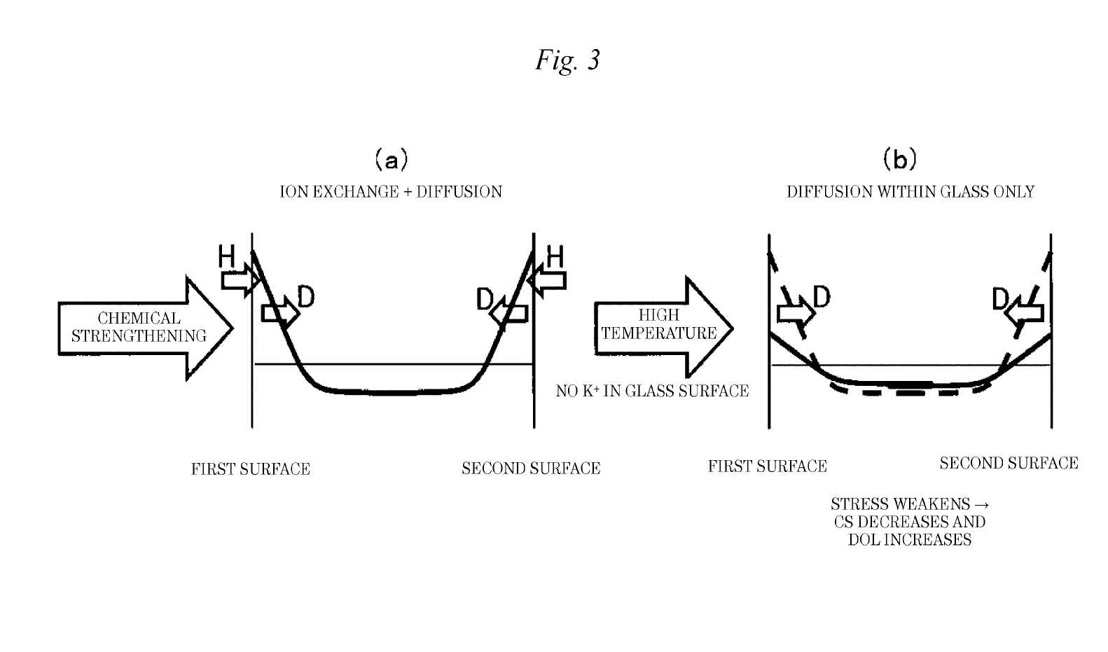

In FIG. 2 is shown a stress profile of a chemically strengthened glass according to one embodiment of the present invention. As shown in FIG. 2, the chemically strengthened glass according to this embodiment has a stress profile which is asymmetrical along the thickness direction and in which the first surface has a depth of stress layer DOL₁ which is larger by at least 3 μm than the depth of stress layer DOL₂ of the second surface and the second surface has a surface compressive stress CS₂ which is higher by at least 50 MPa than the surface compressive stress CS₁ of the first surface.

The depth of stress layer DOL₁ of the first surface is not particularly limited so long as DOL₁ is larger by at least 3 μm than the depth of stress layer DOL₂ of the second surface. However, it is preferable that the depth of stress layer DOL₁ of the first surface is 15 μm or larger, because this first surface has scratch resistance. The depth of stress layer DOL₁ of the first surface is more preferably 20 μm or larger, even more preferably 40 μm or larger.

The depth of stress layer DOL₂ of the second surface is not particularly limited so long as DOL₂ is smaller by at least 3 μm than the depth of stress layer DOL₁ of the first surface. However, from the standpoint of attaining high CS₂, it is preferable that DOL₂ is 5 μm or larger.

The difference (DOL₁−DOL₂) between the depth of stress layer DOL₁ (μm) of the first surface and the depth of stress layer DOL₂ (μm) of the second surface represents a value obtained by subtracting the value of the depth of stress layer DOL₂ (unit: μm) of the second surface from the value of the depth of stress layer DOL₁ (unit: μm) of the first surface. In this embodiment, since the depth of stress layer DOL₁ of the first surface is larger by at least 3 μm than the depth of stress layer DOL₂ of the second surface, DOL₁-DOL₂ is 3 (μm) or larger.

The surface compressive stress CS₁ of the first surface is not particularly limited so long as CS₁ is lower by at least 50 MPa than the surface compressive stress CS₂ of the second surface. However, from the standpoint of scratch resistance, CS₁ is preferably 100 MPa or higher, more preferably 200 MPa or higher, even more preferably 300 MPa or higher.

The surface compressive stress CS₂ of the second surface is not particularly limited so long as CS₂ is higher by at least 50 MPa than the surface compressive stress CS₁ of the first surface. However, from the standpoint of bending resistance, CS₂ is preferably 500 MPa or higher, more preferably 600 MPa or higher, even more preferably 700 MPa or higher.

The difference (CS₁−CS₂) between the surface compressive stress CS₁ (MPa) of the first surface and the surface compressive stress CS₂ (MPa) of the second surface represents a value obtained by subtracting the value of the surface compressive stress CS₂ (unit: MPa) of the second surface from the value of the surface compressive stress CS₁ (unit: MPa) of the first surface. In this embodiment, since the surface compressive stress CS₂ of the second surface is higher by at least 50 MPa than the surface compressive stress CS₁ of the first surface, CS₁−CS₂ is −50 (MPa) or less.

Furthermore, in case where a colliding substance in which the colliding portion has a relatively large angle, e.g., a spherical colliding substance, collides against an exposed surface of a cover glass, then this cover glass is bent, and the surface (back surface) of the cover glass which is on the reverse side from the collision surface and the edge surfaces of the cover glass receive an external force (tensile stress) due to the bending. It is hence desirable that the CS of the back surface of the cover glass and the CS of the edge surfaces of the cover glass should be higher so that the cover glass resists the external force due to the bending. Meanwhile, in the case where the edge surfaces of the cover glass are exposed, there is a possibility that the edge surfaces might suffer a flaw when the display device is dropped and collides against something. It is hence desirable that the DOL of the edge surfaces of the cover glass should be larger.

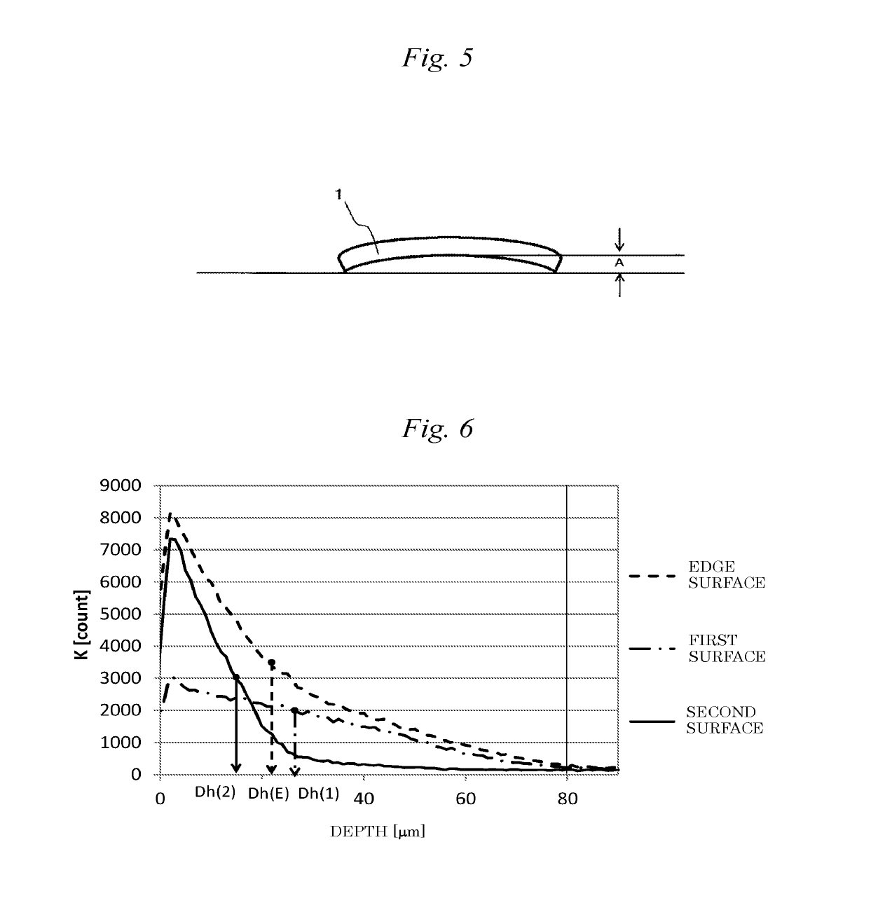

In FIG. 6 is shown an example of the results of a measurement in which the first surface, the second surface, and an edge surface of a chemically strengthened glass according to one embodiment of the present invention were examined for depth-direction replacing-ion X-ray intensity with an EPMA. As shown in FIG. 6, the chemically strengthened glass according to this embodiment satisfies the following relational expressions (2) and (3).

[Dh(E)−Dh(1)]<0 (2)

[Dh(E)−Dh(2)]>0 (3)

By designing a stress profile so that relational expressions (2) and (3) are satisfied and by conducting chemical strengthening treatments to the first surface, second surface, and edge surfaces of a glass substrate, the chemically strengthened glass can be made not only to satisfy the chemically strengthened properties which are desired when the chemically strengthened glass is used as a cover glass but also to have enhanced strength effective against various causes of cracks.

It is preferable that CS₁−CS₂ and DOL₁−DOL₂ satisfy the following relational expression (1).

(CS₁−CS₂)×(DOL₁−DOL₂)<−1,500 (1)

In cases when (CS₁−CS₂)×(DOL₁-DOL₂) is less than −1,500, it is possible to more satisfactorily attain chemically strengthened properties that render the chemically strengthened glass suitable for use in applications where the first surface and the second surface differ in desired chemically strengthened property, that is, chemically strengthened properties which are not symmetrical between the first surface and the second surface and which effectively inhibit or prevent glass fracture. Glass fracture can hence be more effectively prevented. The value of (CS₁−CS₂)×(DOL₁−DOL₂) is more preferably less than −4,000, even more preferably less than −10,000.

As described above, the chemically strengthened glass according to this embodiment has a stress profile which is asymmetrical along the thickness direction and in which the first surface has a depth of stress layer DOL₁ which is larger by at least 3 μm than the depth of stress layer DOL₂ of the second surface and the second surface has a surface compressive stress CS₂ which is higher by at least 50 MPa than the surface compressive stress CS₁ of the first surface. In the chemically strengthened glass according to this embodiment also, tensile stress generates in an inner part of the glass so that the integral of stress along the glass thickness direction becomes 0. According to this embodiment, however, the tensile stress generating in the inner part of the glass can be reduced as compared with a chemically strengthened glass having a stress profile which is symmetrical along the thickness direction (a chemically strengthened glass in which the depth of stress layer DOL of each of both surfaces is equal to the depth of stress layer DOL₁ of the first surface of the chemically strengthened glass of this embodiment and the surface compressive stress CS of each of both surfaces is equal to the surface compressive stress CS₂ of the second surface of the chemically strengthened glass of this embodiment). Consequently, according to this embodiment, the chemically strengthened glass can be made to have lower internal tensile stress CT and can be more effectively inhibited or prevented from suffering glass fracture, as compared with the chemically strengthened glass having a stress profile which is symmetrical along the thickness direction.

The internal tensile stress CT of the chemically strengthened glass according to this embodiment is not particularly limited. However, in cases when the internal tensile stress CT thereof is 100 MPa or less, this chemically strengthened glass is excellent in terms of the effect of inhibiting or preventing glass fracture, and such values of CT are hence preferred. The internal tensile stress CT is more preferably 60 MPa or less, even more preferably 40 MPa or less.

A method is known in which the internal tensile stress CT of a glass is defined as “CT=CS×DOL/(t−2×DOL)” using the surface compressive stress CS and the depth of an outer-region layer DOL, and the value of CT is regulated so as to be in a certain numerical range, thereby controlling the fragility of the chemically strengthened glass (JP-T-2011-530470). In this method, the function of thickness which is called nonlinear limit center tension CT₁ (unit: MIN) is defined as “CT₁=−38.7×ln(t)+48.2” on the basis of Examples relating to aluminosilicate glass having thicknesses t of 0.3−1.5 mm. The document proposes to use a value of the CT₁ as an upper limit of the value of internal tensile stress CT, and that value of CT₁ is regarded as a critical value at which unacceptable fragility starts. For specific applications where glass plates having small thicknesses are used, design flexibility is restricted by “CT₁=−38.7×ln(t)±48.2”.

Next, a process for producing the chemically strengthened glass according to this embodiment is explained.

The glass substrate to be used for this embodiment is not particularly limited so long as the glass substrate is capable of undergoing ion exchange. For example, use can be made of a glass substrate suitably selected from among soda-lime glass, aluminosilicate glass, borosilicate glass, aluminoborosilicate glass, and the like.

Examples of the composition of the glass substrate for use in this embodiment include a glass having a composition which includes, in terms of mol %, 50-80% SiO₂, 0.1-30% Al₂O₃, 3-30% Li₂O+Na₂O+K₂O, 0-25% MgO, 0-25% CaO, and 0-5% ZrO₂. However, the composition thereof is not particularly limited. More specific examples thereof include the following glass compositions. Incidentally, for example, the expression “containing 0-25% MgO” means that MgO, although not essential, may be contained in an amount of up to 25%. (i) A glass having a composition which includes, in terms of mol %, 63-73% SiO₂, 0.1-5.2% Al₂O₃, 10-16% Na₂O, 0-1.5% K₂O, 5-13% MgO, and 4-10% CaO. (ii) A glass having a composition which includes, in terms of mol %, 50-74% SiO₂, 1-10% Al₂O₃, 6-14% Na₂O, 3-11% K₂O, 2-15% MgO, 0-6% CaO, and 0-5% ZrO₂ and in which the total content of SiO₂ and Al₂O₃ is 75% or less, the total content of Na₂O and K₂O is 12-25%, and the total content of MgO and CaO is 7-15%. (iii) A glass having a composition which includes, in terms of mol %, 68-80% SiO₂, 4-10% Al₂O₃, 5-15% Na₂O, 0-1% K₂O, 4-15% MgO, and 0-1% ZrO₂. (iv) A glass having a composition which includes, in terms of mol %, 67-75% SiO₂, 0-4% Al₂O₃, 7-15% Na₂O, 1-9% K₂O, 6-14% MgO, and 0-1.5% ZrO₂ and in which the total content of SiO₂ and Al₂O₃ is 71-75%, the total content of Na₂O and K₂O is 12-20%, and the content of CaO, if it is contained, is less than 1%. (v) A glass having a composition which includes, in terms of mol %, 60-72% SiO₂, 8-16% Al₂O₃, 8-18% Na₂O, 0-3% K₂O, 0-10% MgO, and 0-5% ZrO₂ and in which the content of CaO, if it is contained, is less than 1%.

The glass substrate to be used for the chemically strengthened glass according to this embodiment has two main surfaces, a first surface and a second surface, and further has edge surfaces which adjoin the main surfaces to constitute a thickness. The two main surfaces may be flat surfaces which are parallel with each other. However, the shape of the glass substrate is not limited thereto. For example, the two main surfaces may be ones which are not parallel with each other, and either or both of the two main surfaces may be partly or wholly a curved surface. More specifically, the glass substrate may be, for example, a flat-plate-shaped glass substrate having no warpage, or may be a curved-surface glass substrate having a curved surface.

Either of the main surfaces, i.e., the first surface and the second surface, of the glass substrate may be one in which, in a thickness-direction cross-sectional view, each peripheral edge part has a curved surface shape declining toward the edge surface and constituted of a single curved surface or a combination of multiple curved surfaces. The curved surface shape is a smooth curved surface shape represented by spline curves.

A chamfered surface may be formed between the first or second main surface of the glass substrate and each of the edge surfaces which adjoin the two main surfaces to constitute a thickness. In the case of forming a chamfered surface, the chamfered surface is formed between the main surface which faces the main surface having a curved surface shape and each of the edge surfaces which adjoin the opposed main surfaces to constitute a thickness. The chamfered surface may have an approximately flat shape or a curved surface shape.

The thickness of the glass substrate to be used in this embodiment is not particularly limited.

In a process for producing the chemically strengthened glass according to this embodiment, steps other than a step for chemical strengthening treatment are not particularly limited and may be suitably selected. Typically, conventionally known steps can be applied.

For example, raw materials for the components of the glass are proportioned, and the mixture is heated and melted in a glass melting furnace. Thereafter, the glass is homogenized by bubbling, stirring, addition of a clarifier, etc., formed into a glass substrate having a predetermined thickness by a conventionally known forming method, and cooled gradually.

Examples of methods for forming the glass include a float process, pressing, fusion process, and downdraw process. In particular, a float process is preferred since this process is suitable for mass production. Also preferred are continuous forming methods other than the float process, i.e., a fusion process and a downdraw process.

Thereafter, the glass formed is ground and polished according to need to form a glass substrate. The glass substrate thus formed is subjected to the chemical strengthening treatment described below, and then washed and dried. Thus, a chemically strengthened glass according to this embodiment can be produced.

The chemical strengthening treatment in the process for producing the chemically strengthened glass according to this embodiment is explained below.

In general, the phenomenon of the mutual diffusion of ions in a chemical strengthening treatment occurs in accordance with the diffusion equation shown below. An explanation is given below on the case where the alkali ions which have a larger ionic radius and are subjected to ion exchange are K ions.

$${C}_{x} = {C}_{0} + ( {C}_{eq} - {C}_{0} ) \{ erfc \frac{x}{2 \sqrt{Dt }} - exp ( \frac{H}{D } x + \frac{{H}^{2}}{D} t ) erfc ( \frac{x}{2 \sqrt{Dt}} + \frac{H}{D} \sqrt{Dt} ) \}$$

(t, period (s); x, thickness-direction position from the glass surface (unit: m); Cₓ, K ion concentration (mol %) after the period t at the position x; C₀, initial K ion concentration (mol %); C_{eq}, K ion concentration (mol %) in equilibrium; D, diffusion coefficient (m²/s); H, mass transfer coefficient (m/s).)

The diffusion coefficient D is an index to the rate at which K ions diffuse within the glass. The mass transfer coefficient H is an index to the rate at which K ions penetrate from the glass surface layer into the glass. The diffusion coefficient D and the mass transfer coefficient H both depend on temperature.

In FIG. 3 are shown stress profiles obtained in the case where a glass substrate was immersed in a melt of a metal salt (molten salt) containing K ions to conduct a chemical strengthening treatment and the glass substrate was then taken out from the molten salt and placed at a high temperature. First, a glass substrate is immersed in the molten salt to give a chemical strengthening treatment thereto, upon which the diffusion of ions occurs simultaneously with ion exchange, resulting in the stress profile shown in (a). Thereafter, the glass substrate is taken out from the molten salt and placed at a high temperature. Since the supply of K ions from the molten salt to the glass surface ends, the ion exchange comes not to occur but the diffusion of ions within the glass proceeds because the glass lies in a high-temperature atmosphere. As a result, the stress weakens to reduce the surface compressive stress CS and, simultaneously therewith, the depth of compressive stress layer (DOL) increases. That stress profile hence changes into the stress profile shown by the solid line in (b).

In this embodiment, the above-described phenomenon in which the stress weakens is utilized to produce a chemically strengthened glass having a stress profile which is asymmetrical along the thickness direction and in which the first surface has a depth of stress layer DOL₁ which is larger by at least 3 μm than a depth of stress layer DOL₂ of the second surface and the second surface has a surface compressive stress CS₂ which is higher by at least 50 MPa than a surface compressive stress CS₁ of the first surface. Steps in the chemical strengthening treatment in the process for producing the chemically strengthened glass according to this embodiment are explained using FIG. 4.

As shown in FIG. 4, a chemical strengthening treatment is given first to one surface (first surface) of a glass substrate. In this treatment, ion exchange and the diffusion of ions proceed on the first-surface side, thereby resulting in the stress profile shown in (a). Subsequently, the chemical strengthening treatment of the first surface is stopped, and a chemical strengthening treatment is then given to the other surface (second surface) of the glass substrate. In this treatment, ion exchange and the diffusion of ions proceed on the second-surface side. Meanwhile, on the first-surface side, since no ions for the chemical strengthening treatment are supplied, ion exchange does not occur and, hence, the stress weakens. However, the diffusion of ions proceeds also on the first-surface side because of the influence of the heat due to the chemical strengthening treatment of the second surface. As a result, the stress profile changes to that shown by the solid line in (b).

Thereafter, the chemical strengthening treatment of the second surface is stopped. Thus, a chemically strengthened glass having a stress profile which is asymmetrical along the thickness direction and in which the first surface has a depth of stress layer DOL₁ which is larger by at least 3 μm than the depth of stress layer DOL₂ of the second surface and the second surface has a surface compressive stress CS₂ which is higher by at least 50 MPa than the surface compressive stress CS₁ of the first surface, such as that shown in (c), can be obtained (in this respect, such large value of DOL for the first surface and such large value of CS for the second surface are abbreviated respectively to “large DOL” and “high CS” in (c)).

When giving chemical strengthening treatments to the first surface and second surface of the glass substrate, chemical strengthening treatments can be simultaneously given to the edge surfaces of the glass substrate as well. When giving chemical strengthening treatments to the edge surfaces of the glass substrate, the treatments can be performed while suitably regulating the conditions for each chemical strengthening treatment, the solvent for the inorganic salt(s) to be used for the chemical strengthening treatment, and additives, e.g., a thickener, in accordance with the thickness of the glass substrate.

Specifically, when a chemical strengthening treatment is given to one surface (first surface) of the glass substrate, a chemical strengthening treatment is simultaneously given also to the edge surfaces of the glass substrate. Subsequently, when a chemical strengthening treatment is given to another surface (second surface) of the glass substrate, a chemical strengthening treatment is simultaneously given to the edge surfaces of the glass substrate. Thus, since the edge surfaces are chemically strengthened when a chemical strengthening treatment is given to the first surface and when a chemical strengthening treatment is given to the second surface, the edge surfaces can be strengthened multiple times. Consequently, chemical strengthening treatments can be conducted so as to give a chemically strengthened glass in which the edge surfaces also have a desired stress profile.

Examples of methods for giving a chemical strengthening treatment to one surface of the glass substrate include a method in which the surface to be subjected to the chemical strengthening treatment is coated with one or more inorganic salts and this surface is then heat-treated.

The inorganic salts used in this method serve, for example, to replace alkali metal ions having a small ionic radius (typically, Li ions or Na ions) present in the glass surface with alkali ions having a larger ionic radius (typically, K ions) to form a compressive stress layer in the glass surface. It is, however, noted that ions having a large ionic radius in the glass surface may be replaced with ions having a small ionic radius.

The inorganic salts are not particularly limited in the composition thereof. For example, the inorganic salts include a potassium compound. Examples of the potassium compound include KNO₃, KCl, KBr, KI, KF, and K₂SO₄. Use can also be made of inorganic salts which include a sodium compound, e.g., NaNO₃, besides a potassium compound.

Additives such as a solvent and a thickener may be added to the inorganic salts. Examples of the solvent include a liquid in which the potassium compounds can be dissolved, dispersed, or suspended therein or a substance which is based on such liquid. The solvent may be one which is based on either water or an alcohol. Examples of the thickener include organic resins and organic solvents.

As the organic resins, use may be made of resins which decompose at the heat treatment temperature. Preferred are ones which can be easily removed by water washing. Examples thereof include the following resins having such properties: cellulosic resins, methyl cellulose resins, cellulose acetate resins, cellulose nitrate resins, cellulose acetate butyrate resins, acrylic resins, poly(ethylene oxide) resins, hydroxyethyl cellulose resins, hydroxyethyl methyl cellulose resins, hydroxypropyl cellulose resins, carboxymethyl cellulose sodium resins, hydroxypropyl methyl cellulose resins, xanthan gum resins, (ammonia-modified) isobutylene/maleic anhydride copolymer resins, poly(vinyl alcohol) resins, butenediol/vinyl alcohol copolymer resins, and petroleum resins.

Representative examples of the thickener include the food additives shown below or derivatives thereof. Examples thereof include curdlan, cassia gum, casein, quassia gum, ghatti gum, carrageenan, karaya gum, carob bean gum, xanthan polysaccharide, chitin, chitosan, guar gum, guar flour, glucosamine, gluten, kelp extract, psyllium, psyllium seed gum, psyllium husk, xanthan gum, gellan, gellan gum, gellan polysaccharide, sclero gum, scleroglucan, tamarind, tamarind gum, tamarind seed gum, tara gum, denpul glucole, tragacanth, tragacanth gum, triacanthos, triacanthos gum, and manihot.

The organic solvents preferably are ones in which the metal compounds and the organic resins can be easily dispersed therein and which readily volatilize in drying. Specifically, organic solvents which are liquid at room temperature (20° C.) and which volatilize at about 50-200° C. are preferred. Examples of such organic solvents include alcohols such as methanol and ethanol, dimethyl ether, and ketones such as acetone.

The amounts of additives to be added to the inorganic salt(s) to be used in the present invention are not particularly limited.

It is preferable that the inorganic salts to be used in the present invention are ones, the viscosity of which can be regulated in accordance with processes, from the standpoint of applicability. Examples of methods for viscosity regulation include a method in which a flowability regulator, such as, for example, a clay, e.g., kaolin, water, or aluminosilicate fibers, is added.

Although the viscosity of the inorganic salts to be used in the present invention can be suitably regulated, it is preferable that the viscosity thereof at 20° C. is usually 200-100,000 mPa. The viscosity of the inorganic salts can be measured, for example, with a viscometer (PM-2B, manufactured by Malcom Co., Ltd.) or a viscosity cup (NK-2, manufactured by Anest Iwata Corp.), etc.

Methods for applying the inorganic salts to the front surface and back surface of the glass substrate are not particularly limited, and a known coater may be used. Examples thereof include a curtain coater, bar coater, roll coater, die coater, and spray coating. The inorganic salts may be applied to the edge surfaces of the glass substrate according to need.

The heat treatment temperature may be suitably set in accordance with the kinds of the inorganic salts. Usually, however, the heat treatment temperature is preferably 350-600° C., more preferably 400-550° C.

The period of heat treatment can be suitably set. Usually, however, after a predetermined heat treatment temperature has been reached, the heat treatment is conducted for preferably 5 minutes to 24 hours, more preferably 30 minutes to 4 hours.

For ceasing the chemical strengthening treatment, use may be made, for example, of a method in which the chemically strengthened glass that has been heat-treated is washed to remove the inorganic salts from the surface.

When the amount of ion exchange in the first surface of the glass substrate differs from the amount of ion exchange in the second surface of the glass substrate, there are cases where a difference in expansion arises between the first surface and the second surface to yield a chemically strengthened glass which has warped. Consequently, from the standpoint of preventing the chemical strengthening treatment from causing the warpage, it is preferred to regulate the amount of ion exchange in the first surface of the glass substrate and the amount of ion exchange in the second surface of the glass substrate.

Specifically, the difference between the integral of replacing-ion X-ray intensity (S(1)) from the outermost surface of the first surface of the glass substrate to a depth of 80 μm, as determined with an EPMA, and the integral of replacing-ion X-ray intensity (S(2)) from the outermost surface of the second surface of the glass substrate to a depth of 80 μm, as determined with an EPMA, is preferably 10% or less, more preferably 5% or less, even more preferably 3% or less. However, in the case where the occurrence of warpage due to the chemical strengthening treatments is acceptable, conditions which result in a difference between S(1) and S(2) may be set.

Besides the method described above, examples of methods for producing a chemically strengthened glass having a stress profile which is asymmetrical along the thickness direction include a method in which a film that inhibits the ion exchange (hereinafter referred to also as “ion-exchange inhibition film”) is used. In this method, a glass substrate having an ion-exchange inhibition film disposed on, for example, the second surface is immersed in a molten salt to conduct an ion exchange treatment and is then pulled out from the molten salt. Thereafter, the ion-exchange inhibition film disposed on the second surface is removed, and the glass substrate in which an ion-exchange inhibition film has been disposed on the first surface is immersed in the molten salt to conduct an ion exchange treatment. Thus, a chemically strengthened glass substrate having a stress profile which is asymmetrical along the thickness direction can be produced. Examples of the molten salt include alkali salts of nitric acid, alkali salts of sulfuric acid, and alkali chloride salts, such as potassium nitrate, potassium sulfate, and potassium chloride. One of these molten salts may be used alone, or two or more thereof may be used in combination. In order to regulate the properties to be imparted by chemical strengthening, a salt containing sodium may be incorporated. Conditions for the ion exchange treatment are not particularly limited, and optimal conditions may be selected while taking glass properties, the molten salt, etc. into account.

Applicable besides the method in which an ion-exchange inhibition film is used is, for example, a method in which an inorganic salt is applied to each surface to be subjected to a chemical strengthening treatment and a voltage is applied thereto to thereby implant ions. In this method, a chemically strengthened glass having a stress profile that is asymmetrical along the thickness direction can be produced by performing the ion implantation in one surface at a time, while changing various conditions including voltage and the concentration of the inorganic salt.

In an embodiment of the present invention, the chemically strengthened glass may have a radius of curvature of 15,000 mm or larger. The expression “the chemically strengthened glass has a radius of curvature of 15,000 mm or larger” means that the first surface and second surface of the chemically strengthened glass are a protrudent surface and a recessed surface, respectively, or are a recessed surface and a protrudent surface, respectively, and the observed slightly curved surface has a radius of curvature of 15,000 mm or larger. Such a chemically strengthened glass is obtained, for example, by subjecting a flat-plate-shaped glass substrate to a chemical strengthening treatment such as that described above (ion exchange treatment) under such conditions that the absolute difference between the amount of ion exchange in the first surface and the amount of ion exchange in the second surface is small. In this chemically strengthened glass, the warpage due to the absolute difference between the amounts of ion exchange is small.

In an embodiment of the present invention, the chemically strengthened glass may have a radius of curvature of less than 15,000 mm. The expression “the chemically strengthened glass has a radius of curvature of less than 15,000 mm” means that the first surface and second surface of the chemically strengthened glass are a protrudent surface and a recessed surface, respectively, or are a recessed surface and a protrudent surface, respectively, and the observed curved surface has a radius of curvature of less than 15,000 mm. Such a chemically strengthened glass is obtained, for example, by subjecting a flat-plate-shaped glass substrate to a chemical strengthening treatment such as that described above (ion exchange treatment) under such conditions that the absolute difference between the amount of ion exchange in the first surface and the amount of ion exchange in the second surface is large. In this chemically strengthened glass, the warpage due to the absolute difference between the amounts of ion exchange is large.

A chemically strengthened glass according to an embodiment of the present invention may be one obtained by subjecting a curved-surface glass substrate to the chemical strengthening treatment described above.

In the chemically strengthened glass of the present invention, the integral of replacing-ion X-ray intensity (S(E)) from the outermost surface of each edge surface to a depth of 80 μm, as determined with an EPMA, is larger than the integral of replacing-ion X-ray intensity (S(1)) from the outermost surface of the first surface to a depth of 80 μm, as determined with an EPMA, and than the integral of replacing-ion X-ray intensity (S(2)) from the outermost surface of the second surface to a depth of 80 μm, as determined with an EPMA. Namely, S(E)>S(1) and S(E)>S(2). The chemically strengthened glass which satisfies these relationships is a chemically strengthened glass which has a stress profile that is asymmetrical between the first surface and the second surface and in which the edge surfaces have a stress profile having a high CS and a large DOL.

Such a chemically strengthened glass can be obtained by suitably regulating the conditions for each chemical strengthening treatment, the solvent for the inorganic salts(s) for use in the chemical strengthening treatment, and additives, e.g., a thickener, in accordance with the thickness of the glass substrate so that when giving a chemical strengthening treatment to the first surface, the edge surfaces also undergo the chemical strengthening treatment and that when giving a chemical strengthening treatment to the second surface, the edge surfaces also undergo the chemical strengthening treatment. Since the edge surfaces are chemically strengthened when giving a chemical strengthening treatment to the first surface and when giving a chemical strengthening treatment to the second surface, the edge surfaces can be strengthened multiple times. Thus, chemical strengthening treatments can be conducted so as to give a chemically strengthened glass in which the edge surfaces also have a desired stress profile.

In this description, the term “replacing ions” means ions which, due to an ion exchange treatment as a chemical strengthening treatment, penetrate into the glass to replace ions, i.e., replaced ions, within the glass. Meanwhile, the term “replaced ions” means the ions which, due to an ion exchange treatment, are replaced by the replacing ions to leave the glass. As a result of the ion exchange treatment, the concentration of replacing ions in the glass increases, while the concentration of replaced ions in the glass decreases.

The depth-direction replacing-ion X-ray intensity in each of the first surface, second surface, and edge surfaces of the chemically strengthened glass can be determined with an EPMA (electron probe micro analyzer).

The chemically strengthened glass of the present invention satisfies the following relational expressions (2) and (3).

[Dh(E)−Dh(1)]<0 (2)

[Dh(E)−Dh(2)]>0 (3)

The chemically strengthened glass of the present invention, which satisfies the relational expressions (2) and (3), is a chemically strengthened glass which has a stress profile that is asymmetrical between the first surface and the second surface and in which the edge surfaces have a stress profile having a high CS and a large DOL.

Since not only the first surface and the second surface are chemically strengthened but also the edge surfaces are chemically strengthened so as to have a desired stress profile, cracks starting from any of the edge surfaces can be inhibited from occurring and, hence, glass fracture can be more effectively inhibited or prevented. Consequently, even in the case where the front and back surfaces of a chemically strengthened glass are required to have different chemically strengthened properties and the edge surfaces also are required to have sufficiently chemically strengthened properties, in various applications including the cover glasses of display devices, the chemically strengthened glass of the present invention can satisfy the desired properties and can have enhanced strength effective against various causes of cracks.

Here, Dh(E) is the depth at which, when an edge surface of the chemically strengthened glass is examined with an EPMA, the integral of replacing-ion X-ray intensity from the outermost surface (depth: 0 μm) of the edge surface becomes S(E)/2, where S(E) is the integral of replacing-ion X-ray intensity from the outermost surface of the edge surface to a depth of 80 μm.

Dh(1) is the depth at which, when the first surface of the chemically strengthened glass is examined with an EPMA, the integral of replacing-ion X-ray intensity from the outermost surface (depth: 0 μm) of the first surface becomes S(1)/2, where S(1) is the integral of replacing-ion X-ray intensity from the outermost surface of the first surface to a depth of 80 μm.

Dh(2) is the depth at which, when the second surface of the chemically strengthened glass is examined with an EPMA, the integral of replacing-ion X-ray intensity from the outermost surface (depth: 0 μm) of the second surface becomes S(2)/2, where S(2) is the integral of replacing-ion X-ray intensity from the outermost surface of the second surface to a depth of 80 μm.

Dh(E), Dh(1), and Dh(2) can be calculated from the results of examinations of the edge surface, first surface, and second surface of the chemically strengthened glass for depth-direction replacing-ion X-ray intensity with an EPMA.

The chemically strengthened glass of the present invention, which satisfies relational expressions (2) and (3), satisfies the following relational expression (4).

[Dh(E)−Dh(1)]×[Dh(E)−Dh(2)]<0 (4)

As explained above, the chemically strengthened glass of the present invention not only has a stress profile which is asymmetrical along the thickness direction and in which the first surface has a depth of stress layer DOL₁ that is larger by at least 3 μm than the depth of stress layer DOL₂ of the second surface and the second surface has a surface compressive stress CS₂ that is higher by at least 50 MPa than the surface compressive stress CS₁ of the first surface, but also satisfies the following relational expressions (2) and (3).

[Dh(E)−Dh(1)]<0 (2)

[Dh(E)−Dh(2)]>0 (3)

The chemically strengthened glass of the present invention can hence be reduced in the tensile stress generating in the inner part of the glass as compared with a chemically strengthened glass having a stress profile which is symmetrical along the thickness direction (a chemically strengthened glass in which the depth of stress layer DOL of each of both surfaces is equal to the depth of stress layer DOL₁ of the first surface of the chemically strengthened glass of this embodiment and the surface compressive stress CS of each of both surfaces is equal to the surface compressive stress CS₂ of the second surface of the chemically strengthened glass of this embodiment) and has a desired stress profile also with respect to the edge surfaces. Consequently, according to the present invention, the chemically strengthened glass can be made to have lower internal tensile stress CT and can hence be more effectively inhibited or prevented from suffering glass fracture, as compared with the chemically strengthened glass having a stress profile which is symmetrical along the thickness direction.

The chemically strengthened glass of the present invention is useful as, for example, the cover glasses of personal digital assistants such as cell phones and smartphones and of display devices, e.g., those of TV's, personal computers, and touch panels. Specifically, in the cover glasses of display devices, there is a possibility that various substances might collide against the surface of the cover glass on the exposed side (exposed surface) to damage the glass. For example, in case where a colliding substance in which the colliding portion has a relatively large angle, e.g., a spherical colliding substance, collides against the exposed surface of the cover glass, then this cover glass is bent and the surface (back surface) of the cover glass which is on the reverse side from the collision surface and the edge surfaces of the cover glass receive an external force (tensile stress) due to the bending. It is hence desirable that the surface compressive stress (CS) of the back surface of the cover glass and the surface compressive stress (CS) of the edge surfaces of the cover glass should be higher so that the cover glass resists the external force due to the bending. Meanwhile, there are cases where a colliding substance in which the colliding portion has a relatively small angle, e.g., a colliding substance having a sharp end, collides against the exposed surface of the cover glass to form a flaw in the exposed surface of the cover glass. In case where the flaw extends deeper than the compressive stress layer and the internal tensile stress is high, this cover glass cracks. Consequently, from the standpoint that a cover glass has flaw resistance, it is desirable that the depth of compressive stress layer (DOL) of the exposed surface of the cover glass should be larger and the internal tensile stress (CT) thereof should be lower.

In this respect, since the chemically strengthened glass of the present invention is one in which the depth of compressive stress layer DOL₁ of the first surface is larger by at least 3 μm than the depth of compressive stress layer DOL₂ of the second surface and the surface compressive stress CS₂ of the second surface is higher by at least 50 MPa than the surface compressive stress CS₁ of the first surface and in which the edge surfaces have a stress profile having a high CS and a large DOL, this chemically strengthened glass can be made to satisfy the properties required for the cover glasses of display devices, for example, by disposing the chemically strengthened glass so that the first surface, which has a larger depth of compressive stress layer, is the exposed surface and the second surface, which has a higher surface compressive stress, is the back surface. Furthermore, the edge surfaces also can satisfy desired chemically strengthened properties. In addition, since the internal tensile stress CT thereof can be further reduced, glass fracture can be more effectively inhibited or prevented. Consequently, the chemically strengthened glass of the present invention is suitable for use as the cover glasses of display devices.

Furthermore, the chemically strengthened glass of the present invention is useful also in various applications where the chemically strengthened properties which the chemically strengthened glass is desired to have differ from surface to surface, besides being suitable for use as the cover glasses of display devices. For example, the chemically strengthened glass of the present invention is useful as building materials such as window glasses for architecture including houses and buildings, automotive members for use in vehicles such as motor vehicles (e.g., windshields, mirrors, window glasses, interior trim members, etc.), optical lenses, medical appliances or instruments, tableware, etc.

### EXAMPLES

The present invention is explained below with referenced to Examples, but the present invention is not limited by the following Examples.

### Example 1

First, a glass having the composition shown below was produced by a float process so that the glass had a thickness of 0.85 mm. This glass plate was cut into a size of 50 mm×50 mm to produce a glass substrate. The glass substrate produced had no warpage.

Glass composition (in mol %): SiO₂ 64.4%, Al₂O₃ 8.0%, Na₂O 12.5%, K₂O 4.0%, MgO 10.5%, CaO 0.1%, SrO 0.1%, BaO 0.1%, ZrO₂ 0.5%

Subsequently, pasty inorganic salts having the composition shown below were applied with a coater to one surface (first surface) of the produced glass substrate in a thickness of 1.5 mm.

Composition of pasty inorganic salts (mass ratio): water/K₂SO₄/KNO₃=6/5/1

The glass substrate on which the pasty inorganic salts had been applied to the first surface was transferred to the inside of a heating oven and heat-treated at 500° C. for 15 minutes to thereby perform a chemical strengthening treatment. Thereafter, the glass substrate was cooled to room temperature, washed with pure water to remove the inorganic salts applied to the first surface, and dried.

Subsequently, pasty inorganic salts having the same composition as those applied to the first surface were applied to the second surface of the glass substrate in the same amount as for the first surface. Thereafter, this glass substrate was transferred to the inside of a heating oven, and a heat treatment was conducted under the conditions of a heat treatment temperature of 400° C. and a heat treatment period of 200 minutes, thereby performing a chemical strengthening treatment. The glass substrate was then cooled to room temperature, washed with pure water to remove the inorganic salts applied to the second surface, and dried to obtain a chemically strengthened glass of Example 1. Incidentally, the edge surfaces of the thus-obtained chemically strengthened glass of Example 1 had been chemically strengthened by both the chemical strengthening treatment performed after the application of inorganic salts to the first surface and the chemical strengthening treatment performed after the application of inorganic salts to the second surface.

### Comparative Example 1

A glass substrate which was the same as that produced in Example 1 was immersed in 450° C. molten KNO₃ for 60 minutes to conduct a chemical strengthening treatment. Thereafter, the glass substrate was cooled to room temperature, washed with pure water, and then dried, thereby obtaining a chemically strengthened glass of Comparative Example 1.

### Comparative Example 2

A chemically strengthened glass of Comparative Example 2 was obtained in the same manner as in Comparative Example 1, except that the period of the chemical strengthening treatment was changed to 150 minutes.

(Surface Compressive Stress CS₁ and CS₂)

The surface compressive stress CS₁ (MPa) of the first surface of each of the chemically strengthened glasses obtained in Examples 1 to 6 and Comparative Examples 1 to 7 and the surface compressive stress CS₂ (MPa) of the second surface thereof were measured using a surface stress meter (FSM-6000LE) manufactured by Orihara Industrial Co., Ltd. The results thereof are shown in Table 1, Table 3, and Table 5. With respect to each of Examples 1 to 6 and Comparative Examples 1 to 7, two samples were produced (n1 and n2 in Table 1), and the measurement was made on each sample. The results of the measurements are shown in Table 1, Table 3, and Table 5.

(Depth of Compressive Stress Layer DOL₁ and DOL₂)

The depth of compressive stress layer DOL₁ (μm) of the first surface of each of the chemically strengthened glasses obtained in Examples 1 to 6 and Comparative Examples 1 to 7 and the depth of compressive stress layer DOL₂ (μm) of the second surface thereof were measured using a surface stress meter (FSM-6000LE) manufactured by Orihara Industrial Co., Ltd. The results thereof are shown in Table 1, Table 3, and Table 5. As in the measurements of surface compressive stress, two samples were produced with respect to each of Examples 1 to 6 and Comparative Examples 1 to 7, and the measurement was made on each sample. The results of the measurements are shown in Table 1, Table 3, and Table 5.

Furthermore, (CS₁−CS₂)×(DOL₁−DOL₂)=ΔCS×ΔDOL was calculated from the measured values of the surface compressive stress CS₁ (MPa) of the first surface, surface compressive stress CS₂ (MPa) of the second surface, depth of compressive stress layer DOL₁ (μm) of the first surface, and depth of compressive stress layer DOL₂ (μm) of the second surface. The results of the calculations are shown in Table 1, Table 3, and Table 5. As in the measurements of surface compressive stress, two samples were produced with respect to each of Examples 1 to 6 and Comparative Examples 1 to 7, and the calculation was made with respect to each sample. The results of the calculations are shown in Table 1, Table 3, and Table 5.

### (Internal Tensile Stress CT)

On the basis of a general relational expression for CT, the internal tensile stress CT was derived using the following equation.

CT=(CS₁ [MPa]×DOL₁ [mm]+CS₂ [MPa]×DOL₂ [mm])/2(t [mm]−(DOL₁ [mm]+DOL₂ [mm]))

The results of the calculations are shown in Table 1, Table 3, and Table 5. As in the measurements of surface compressive stress, two samples were produced with respect to each of Examples 1 to 6 and Comparative Examples 1 to 7, and the calculation was made with respect to each sample. The results of the calculations are shown in Table 1, Table 3, and Table 5.

### (Warpage Amount)

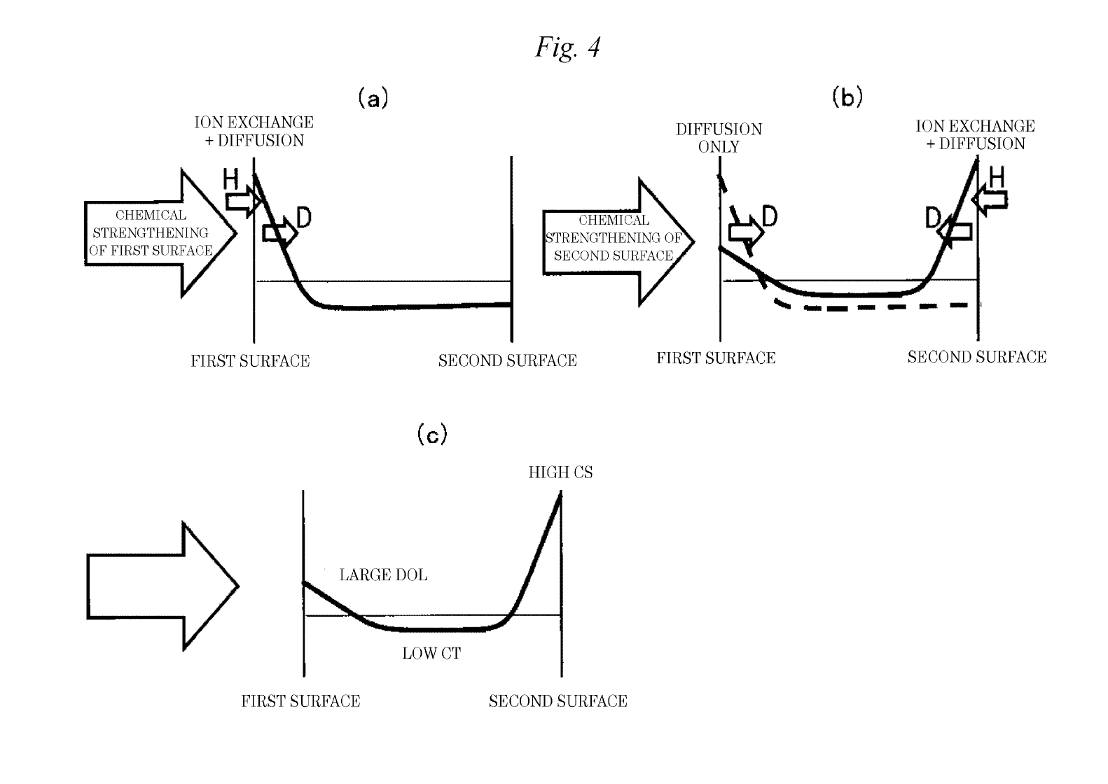

The chemically strengthened glasses obtained were further examined for warpage amount (μm). As shown in FIG. 5, the warpage amount is determined by measuring the maximum warpage A, in terms of warpage from horizontal, of the warped glass substrate 1. The warpage amount can be measured with contact type surface shape measuring device “Surfcom 1400D (trade name)”, manufactured by Tokyo Seimitsu Co., Ltd. The results thereof are shown in Table 1, Table 3, and Table 5. As in the measurements of surface compressive stress, two samples were produced with respect to each of Examples 1 to 6 and Comparative Examples 1 to 7, and the measurement was made on each sample. The results of the measurements are shown in Table 1, Table 3, and Table 5.

TABLE 1

| | | Measured values of stress | | | | | | |
|---|---|---|---|---|---|---|---|---|
| | | First | | Second | | | | |
| | | surface | | surface | | Warpage | | |
| | | CS₁ | DOL₁ | CS₂ | DOL₂ | A | ΔCS × | CT |
| | | [MPa] | [μm] | [MPa] | [μm] | [μm] | ΔDOL | [MPa] |
| Example | n1 | 352.8 | 47.2 | 760.6 | 31.3 | 29.9 | −6473.3 | 28.3 |
| 1 | n2 | 365.9 | 47.4 | 768.6 | 31.9 | 24.7 | −6241.3 | 33.6 |
| Compar- | n1 | 749.0 | 30.7 | 753.3 | 30.3 | 5.6 | −2.0 | 27.2 |
| ative | n2 | 748.1 | 30.9 | 751.0 | 30.4 | 6.2 | −1.4 | 29.0 |
| Example | | | | | | | | |
| 1 | | | | | | | | |
| Compar- | n1 | 758.3 | 47.8 | 750.4 | 45.2 | 11.2 | 20.3 | 29.1 |
| ative | n2 | 758.9 | 47.7 | 750.2 | 45.5 | 12.5 | 18.8 | 46.3 |
| Example | | | | | | | | |
| 2 | | | | | | | | |

### (Ring-On-Ring Test)

A ring-on-ring test was given to the chemically strengthened glasses of Example 1 and Comparative Examples 1 and 2 in order to compare the chemically strengthened glasses in bending resistance. Each chemically strengthened glass was horizontally placed on a receiving jig (ring having a diameter of 30 mm) so that the second surface thereof faced downward, and a pressing jig (ring having a radius of 10 mm) made of SUS304 was used to press the chemically strengthened glass. The descending speed of the pressing jig was set at 0.5 (mm/min). The load (N) at the time when the chemically strengthened glass was broken by the pressing was measured, and this operation was repeatedly performed ten times. An average for the ten measurements was taken as average ring-on-ring strength R₁ (N). The results thereof are shown in Table 2.

### (Sand-Paper Falling Ball Test)

In order to compare the chemically strengthened glasses of Example 1 and Comparative Examples 1 and 2 in flawing strength, each chemically strengthened glass was subjected to an impact test, in which the chemically strengthened glass was disposed on a base table, and a sand paper containing an abrasive material having a size larger than the depth of the compressive stress layer was placed on the chemically strengthened glass so that the rubbing surface thereof was in contact with the first surface of the chemically strengthened glass. An impactor was dropped from above on the chemically strengthened glass in that state. A scattering preventive film was applied to the second surface of the chemically strengthened glass, which was not in contact with the rubbing surface of the sand paper. An iron plate was disposed in the center of the lower platen of a falling ball tester, and a rubber sheet having a thickness of 1 mm was disposed thereon to configure the base table. The chemically strengthened glass was disposed on the base table so that the second surface thereof, to which a scattering preventive film had been applied, was in contact with the base table, and a sand paper (grain size #30; commercial product meeting the JIS R 6251 standards) of 25 mm×25 mm was disposed in the center of the first surface of the chemically strengthened glass so that the rubbing surface thereof was in contact with the first surface. A stainless-steel ball having a weight of 64 g and a diameter of 25 mm was dropped along the center axis of the falling ball tester from a height of 20 mm, which was elevated 10 mm by 10 mm. The height which resulted in cracking was recorded, and an average for five tests was taken as the average breakage height (mm) in sand-paper falling ball test. The results thereof are shown in Table 2.

TABLE 2

| | | Average breakage height in |
|---|---|---|
| | Average ROR | sand-paper falling ball test |
| | strength R1 [N] | [mm] |
| Example 1 | 1.49 | 258 |
| Comparative Example 1 | 1.53 | 206 |
| Comparative Example 2 | 1.35 | 66 |

### Example 2

First, a glass having the composition shown below was produced by a float process, and the edge surfaces of the glass were polished with a grindstone #325 to produce a glass substrate having a size of 60 mm×120 mm×0.56 mm (thickness).

Glass composition (in mol %): SiO₂ 68.0%, Al₂O₃ 10.0%, Na₂O 14.0%, MgO 8.0%

Subsequently, 2.3 g of a powder having the composition shown below was applied with a coater to one surface (first surface) of the glass substrate in an even thickness.

Composition of powder (mass ratio): KNO₃/K₂SO₄=1/1

The glass substrate on which the powder had been applied to the first surface was transferred to the inside of a heating oven and burned at 450° C. for 90 minutes to thereby perform a chemical strengthening treatment. Thereafter, the glass substrate was cooled to room temperature, washed with pure water to remove the powder applied to the first surface, and dried.

Subsequently, a powder having the same composition as that applied to the first surface was applied to the second surface of the glass substrate in the same amount as for the first surface. Thereafter, this glass substrate was transferred to the inside of a heating oven, and a heat treatment was conducted under the conditions of a heat treatment temperature of 450° C. and a heat treatment period of 80 minutes, thereby performing a chemical strengthening treatment. The glass substrate was then cooled to room temperature, washed with pure water to remove the powder applied to the second surface, and dried to obtain a chemically strengthened glass of Example 2. Incidentally, the edge surfaces of the thus-obtained chemically strengthened glass of Example 2 had been chemically strengthened by both the chemical strengthening treatment performed after the application of inorganic salts to the first surface and the chemical strengthening treatment performed after the application of inorganic salts to the second surface. This applies in Example 3, which is described below.

### Example 3

A chemically strengthened glass of Example 3 was obtained in the same manner as in Example 2, except that when producing a glass substrate, the edge surfaces of the glass were polished with a grindstone #600.

### Example 4

First, the same glass substrate as in Example 2 was prepared. Subsequently, 2.3 g of a powder having the composition shown below was applied with a coater to one surface (first surface) of the glass substrate in an even thickness.

Composition of powder (mass ratio): KNO₃/K₂SO₄=1/1

The glass substrate on which the powder had been applied to the first surface was transferred to the inside of a heating oven and burned at 450° C. for 105 minutes to thereby perform a chemical strengthening treatment. Thereafter, the glass substrate was cooled to room temperature, washed with pure water to remove the powder applied to the first surface, and dried. Next, this glass substrate in the state of being uncoated with any powder was burned in a 450° C. heating oven for 15 hours.

Subsequently, a powder having the same composition as that applied to the first surface was applied to the second surface of the glass substrate in the same amount as for the first surface. Thereafter, this glass substrate was transferred to the inside of a heating oven, and a heat treatment was conducted under the conditions of a heat treatment temperature of 450° C. and a heat treatment period of 90 minutes, thereby performing a chemical strengthening treatment. The glass substrate was then cooled to room temperature, washed with pure water to remove the powder applied to the second surface, and dried to obtain a chemically strengthened glass of Example 4. Incidentally, the edge surfaces of the thus-obtained chemically strengthened glass of Example 4 had been chemically strengthened by both the chemical strengthening treatment performed after the application of inorganic salts to the first surface and the chemical strengthening treatment performed after the application of inorganic salts to the second surface. This applies in Example 5, which is described below.

### Example 5

A chemically strengthened glass of Example 5 was obtained in the same manner as in Example 4, except that when producing a glass substrate, the edge surfaces of the glass were polished with a grindstone #600.

### Comparative Example 3

The same glass substrate as in Example 2 was immersed at 450° C. for 100 minutes in molten salts including, in terms of mass ratio, 95.5% KNO₃ and 4.5% NaNO₃, thereby performing a chemical strengthening treatment. Thereafter, the glass substrate was cooled to room temperature, washed with pure water, and then dried to obtain a chemically strengthened glass of Comparative Example 3.

### Comparative Example 4

A chemically strengthened glass of Comparative Example 4 was obtained in the same manner as in Comparative Example 3, except that when producing a glass substrate, the edge surfaces of the glass were polished with a grindstone #600.

### Example 6

First, a glass having the composition shown below was produced by a float process so that the glass had a thickness of 0.70 mm. This glass plate was cut into a size of 120 mm×60 mm, with a corner radius of 3 mm, thereby producing a glass substrate. The glass substrate produced had no warpage.

Glass composition (in mol %): SiO₂ 64.4%, Al₂O₃ 8.0%, Na₂O 12.5%, K₂O 4.0%, MgO 10.5%, CaO 0.1%, SrO 0.1%, BaO 0.1%, ZrO₂ 0.5%

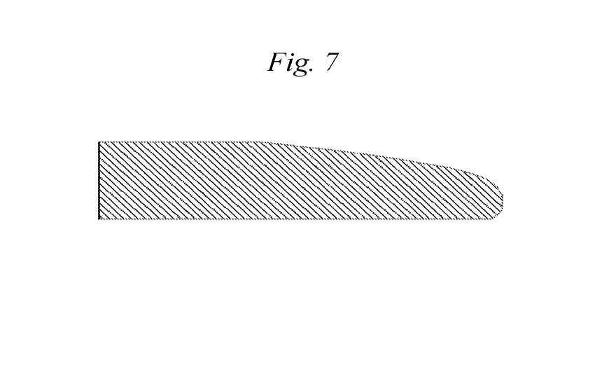

Subsequently, a main surface of the glass substrate produced was polished so that a peripheral edge part of the main surface came to have a curved surface shape. The curved surface shape formed by the polishing was a spline curve shape having a front-surface width of 2 mm and a height of 0.50 mm (See FIG. 7). Thereafter, the edge surfaces of the glass substrate were polished. Furthermore, the boundary between the main surface which faced the main surface having the curved surface shape at the peripheral edge part and each of the edge surfaces which adjoined that main surface to constitute the thickness was subjected to 0.10-mm C-chamfering polishing to form a chamfered surface. This polishing was conducted with a grindstone #600.

Next, pasty inorganic salts having the composition shown below were applied with a coater to one surface (first surface) of the produced glass substrate in a thickness of 0.2 mm.

Composition of pasty inorganic salts (mass ratio): vehicle/K₂SO₄/KNO₃=9/9/1

The vehicle was produced by adding 2% hydroxyethyl cellulose to H₂O.

The glass substrate on which the pasty inorganic salts had been applied to the first surface thereof was transferred to the inside of a heating oven and heat-treated at 420° C. for 18 hours to thereby perform a chemical strengthening treatment. Thereafter, the glass substrate was cooled to room temperature, washed with pure water to remove the inorganic salts applied to the first surface, and dried.

Subsequently, 2.3 g of a powder having the composition shown below was applied with a coater to the second surface of the glass substrate in an even thickness.

Composition of powder (mass ratio): KNO₃/K₂SO₄=1/1

Thereafter, the glass substrate was transferred to the inside of a heating oven and heat-treated under the conditions of a heat treatment temperature of 420° C. and a heat treatment period of 8 hours to thereby perform a chemical strengthening treatment. The glass substrate was then cooled to room temperature, washed with pure water to remove the inorganic salts applied to the second surface, and dried.

Subsequently, the powder was applied again to the second surface of the glass substrate in the same amount. This glass substrate was transferred to the inside of a heating oven, and a heat treatment was conducted under the conditions of a heat treatment temperature of 450° C. and a heat treatment period of 15 minutes, thereby performing a chemical strengthening treatment. The glass substrate was then cooled to room temperature, washed with pure water to remove the inorganic salts applied to the second surface, and dried to obtain a chemically strengthened glass of Example 6. Incidentally, the edge surfaces of the thus-obtained chemically strengthened glass of Example 6 had been chemically strengthened by all of the chemical strengthening treatment performed after the application of inorganic salts to the first surface and the two chemical strengthening treatments performed after the application of inorganic salts to the second surface.

### Comparative Example 5

The same glass substrate as in Example 6 was immersed in molten KNO₃ at 450° C. for 120 minutes, thereby performing a chemical strengthening treatment. Thereafter, the glass substrate was cooled to room temperature, washed with pure water, and then dried to obtain a chemically strengthened glass of Comparative Example 5.

### Comparative Example 6

The same glass substrate as in Example 6 was immersed in molten KNO₃ at 450° C. for 240 minutes, thereby performing a chemical strengthening treatment. Thereafter, the glass substrate was cooled to room temperature, washed with pure water, and then dried to obtain a chemically strengthened glass of Comparative Example 6.

### Comparative Example 7

The same glass substrate as in Example 6 was immersed in molten KNO₃ at 450° C. for 360 minutes, thereby performing a chemical strengthening treatment. Subsequently, the glass substrate was transferred to the inside of a heating oven, and a heat treatment was conducted under the conditions of a heat treatment temperature of 475° C. and a heat treatment period of 480 minutes. Thereafter, the glass substrate was cooled to room temperature, washed with pure water, and then dried to obtain a chemically strengthened glass of Comparative Example 7.

An explanation is given below on a method for reproducing the cracking of a chemically strengthened glass of the present invention. First, the mechanism by which the chemically strengthened glass is damaged when the personal digital assistant is dropped is explained, the mechanism having been found by the present inventors. Here, the outer surface of the chemically strengthened glass is called a front surface (exposed surface), while the surface thereof on the display side is called a back surface. In personal digital assistants each equipped with a display, such as smartphones, chemically strengthened glasses are used as the cover glasses for protecting the displays.

When such a personal digital assistant is dropped onto a receiving surface (e.g., asphalt or concrete), either the front surface of the chemically strengthened glass or an edge surface of the chemically strengthened glass first comes into contact with the receiving surface and there are cases where a flaw that is causative of glass cracking is formed and tensile stress generates in the whole glass because of the impact of the dropping, resulting in cracking of the glass. In such cases, the cracking is less apt to occur when the depth of a compressive stress layer (DOL), which serves to prevent crack propagation even after the generation of tensile stress, is sufficiently large. In addition, there are cases where upon the contact of the front surface or edge surface of the chemically strengthened glass with a receiving surface, high tensile stress generates in the back surface of the chemically strengthened glass, resulting in cracking of the chemically strengthened glass. In such cases, the cracking is less apt to occur when the back surface and the edge surfaces have a high surface compressive stress (CS).

In the case where the chemically strengthened glass is damaged by, for example, such dropping which is accompanied with impact force, the cause of the damage or cracking differs depending on which portion of the chemically strengthened glass has first comes into contact with the receiving surface (e.g., asphalt or concrete).

An explanation is given below on a method in which the impact force that is applied to the chemically strengthened glass when the personal digital assistant is dropped onto a receiving surface is reproduced and the impact strength is tested.

### (Set Dropping Test)

A chemically strengthened glass has a first surface and a second surface which are main surfaces parallel with each other and further has edge surfaces that are perpendicular to the main surfaces and are substantially flat. The peripheral edge part of each main surface may have a curved surface shape declining toward the edge surface. The chemically strengthened glass has been formed so as to be symmetrical with respect to a center plane between both main surfaces.

The cracking resistance of a chemically strengthened glass was evaluated through the set dropping test. The test method was as follows. Asphalt, a sand paper (graininess: G80), or a sand paper (graininess: G120) was laid on stainless steel, and the chemically strengthened glass which had been mounted in a jig was dropped thereonto, with the glass side facing downward. Thereafter, the main surface and edge surfaces of the chemically strengthened glass were visually examined for a crack. In the case where no crack has occurred, the dropping height from which the chemically strengthened glass was dropped was elevated to repeat the test. The elevated dropping height which resulted in the occurrence of a crack in the main surface or an edge surface of the chemically strengthened glass was taken as a cracking height (cm) to evaluate the cracking resistance.

Incidentally, the chemically strengthened glass in the state of having been mounted in a jig was subjected to the set dropping test. The reason for this is as follows. Impacts to be imposed on this personal digital assistant upon dropping in cases when the chemically strengthened glass is used as the cover glass of the display provided to a personal digital assistant are reproduced. Because of this, the chemically strengthened glass has been fixed so that the chemically strengthened glass does not lift up from the jig (which is a substitute for the housing of a personal digital assistant). The set dropping test is a test method suitable for testing the practical strength of a chemically strengthened glass used as the cover glass of a personal digital assistant.

Each of the chemically strengthened glasses of Example 6 and Comparative Examples 5 to 7 was subjected to the set dropping test to evaluate the cracking resistance of the chemically strengthened glass. The cracking heights (cm) obtained by the evaluation are inclusively shown in Table 7. Each cracking height (cm) is an average value obtained from a plurality of test samples.

With respect to each of Examples 2 to 5 and Comparative Examples 3 and 4, two test samples were produced (n1 and n2 in Table 3). With respect to each of Example 6 and Comparative Examples 5 to 7, fifteen test samples were produced (Table 7).

With respect to each of the chemically strengthened glasses of Examples 2 to 6 and Comparative Examples 3 to 7, the surface compressive stresses CS₁ and CS₂, depths of compressive stress layer DOL₁ and DOL₂, ΔCS×ΔDOL, internal tensile stress CT, and warpage amount (maximum warpage A) were measured or calculated in the same manners as in Example 1 and Comparative Examples 1 and 2. The results thereof are shown in Table 3 and Table 5.

### (Depth-Direction K-Ion X-Ray Intensity Profile in First Surface, Second Surface, and Edge Surface)

With respect to each of the chemically strengthened glasses of Examples 2 to 6 and Comparative Examples 3 to 7, the depth-direction K-ion X-ray intensity in each of the first surface, the second surface, and an edge surface was measured with an EPMA (electron probe micro analyzer) to determine the S_{K}(E), S_{K}(1), and S_{K}(2) shown below. Furthermore, the Dh_{K}(E), Dh_{K}(1), and Dh_{K}(2) shown below were calculated from the results of the measurements.

The measurement with an EPMA was conducted in the following manner. First, a glass specimen was embedded in an epoxy resin, and the embedded specimen was subjected to machine grinding along a direction perpendicular to the first and second surfaces to produce a cross-section specimen. The cross-section obtained by the grinding was subjected to C-coating and then examined with an EPMA (electron probe micro analyzer JXA-8500F, manufactured by JEOL Ltd.). A measurement was made at intervals of 1 μm under the conditions of an accelerating voltage of 15 kV, probe current of 30 nA, and integration period of 1,000 msec/point to acquire a line profile of X-ray intensity for K.

S_{K}(E): the integral of K-ion X-ray intensity from the outermost surface of the edge surface of the chemically strengthened glass to a depth of 80 vim in the examination of the edge surface with the EPMA.

S_{K}(1): the integral of K-ion X-ray intensity from the outermost surface of the first surface of the chemically strengthened glass to a depth of 80 vim in the examination of the first surface with the EPMA.

S_{K}(2): the integral of K-ion X-ray intensity from the outermost surface of the second surface of the chemically strengthened glass to a depth of 80 vim in the examination of the second surface with the EPMA.

Dh_{K}(E): the depth at which, when the edge surface of the chemically strengthened glass is examined with the EPMA, the integral of K-ion X-ray intensity from the outermost surface of the edge surface becomes S_{K}(E)/2, where S_{K}(E) is the integral of K-ion X-ray intensity from the outermost surface of the edge surface to a depth of 80 μm.

Dh_{K}(1): the depth at which, when the first surface of the chemically strengthened glass is examined with the EPMA, the integral of K-ion X-ray intensity from the outermost surface of the first surface becomes S_{K}(1)/2, where S_{K}(1) is the integral of K-ion X-ray intensity from the outermost surface of the first surface to a depth of 80 μm.

Dh_{K}(2): the depth at which, when the second surface of the chemically strengthened glass is examined with the EPMA, the integral of K-ion X-ray intensity from the outermost surface of the second surface becomes S_{K}(2)/2, where S_{K}(2) is the integral of K-ion X-ray intensity from the outermost surface of the second surface to a depth of 80 μm.

Furthermore, [Dh_{K}(E)−Dh_{K}(1)], [Dh_{K}(E)−Dh_{K}(2)], and [Dh_{K}(E)−Dh_{K}(1)]×[Dh_{K}(E)−Dh_{K}(2)] were calculated from the calculated values of Dh_{K}(E), Dh_{K}(1), and Dh_{K}(2). The results thereof are collectively shown in Table 4 and Table 6.

As shown in Table 4, Table 6, and FIG. 6, the chemically strengthened glasses of the present invention satisfy the following relational expressions (2) and (3).

[Dh(E)−Dh(1)]<0 (2)

[Dh(E)−Dh(2)]>0 (3)

Namely, the value of Dh(E) is less than the value of Dh(1) and exceeds the value of Dh(2).

The chemically strengthened glasses of the present invention each have a stress profile in which the first surface has a depth of (compressive) stress layer DOL₁ which is larger by at least 3 μm than the depth of (compressive) stress layer DOL₂ of the second surface and the second surface has a surface compressive stress CS₂ which is higher by at least 50 MPa than the surface compressive stress CS₁ of the first surface. In addition, by designing a stress profile so as to satisfy relational expressions (2) and (3), the edge surfaces are made to have a stress profile having a high CS and a large DOL.

By thus making the edge surfaces have a stress profile having a high CS and a large DOL, the chemically strengthened glass can be made to resist external force (tensile stress) due to the bending occurring in an edge surface of the chemically strengthened glass when a colliding substance in which the colliding portion has a relatively large angle, e.g., a spherical colliding substance, collides against the exposed surface of the edge surface, because the edge surface has a high CS. Furthermore, there is a possibility that in cases when an edge surface of a chemically strengthened glass receives impact force, a flaw that is causative of glass cracking might be formed in the edge surface by the colliding substance. The chemically strengthened glasses of the present invention which have a large DOL are capable of inhibiting crack propagation even after generation of tensile stress, and can be inhibited or prevented from cracking.

Each of the chemically strengthened glasses of Example 6 and Comparative Examples 5 to 7 was subjected to the set dropping test to evaluate the cracking resistance of the chemically strengthened glass. The main surface and edge surfaces were evaluated for practical strength. The cracking heights (cm) obtained by the evaluation are inclusively shown in Table 7.

Example 6 had a cracking height of 87.7 cm in the case where the receiving surface was asphalt, a cracking height of 188.0 cm in the case where the receiving surface was a sand paper (graininess: G120), and a cracking height of 128.3 cm in the case where the receiving surface was a sand paper (graininess: G80). The chemically strengthened glass of Example 6 has a large cracking height in dropping onto any of the receiving surfaces. Meanwhile, Comparative Examples 5 to 7 each had small values of cracking height. Namely, the chemically strengthened glass of Example 6 is a chemically strengthened glass in which not only the first and second surfaces but also the edge surfaces have sufficient strength and which has excellent practical strength.

As shown above, the chemically strengthened glass of the present invention is designed to have all of the following stress profiles so as to have enhanced resistance to cracks which occur by various causes.

1) The depth of compressive stress layer DOL₁ of the first surface is larger by at least 3 μm than the depth of compressive stress layer DOL₂ of the second surface. By designing the chemically strengthened glass to have this stress profile, the flaw resistance can be heightened.

2) The surface compressive stress CS₂ of the second surface is higher by at least 50 MPa than the surface compressive stress CS₁ of the first surface. By designing the chemically strengthened glass to have this stress profile, the bending resistance can be heightened.

3) The chemically strengthened glass satisfies relational expressions (2) and (3).

[Dh(E)−Dh(1)]<0 (2)

[Dh(E)−Dh(2)]>0 (3)

Namely, the edge surfaces of the chemically strengthened glass have a stress profile having a high CS and a large DOL. The high CS enables the edge surfaces to show enhanced cracking resistance when external force (tensile stress) due to bending is imposed thereon, while the large DOL renders a flaw formed in any of the edge surfaces less apt to grow and can thus heighten the cracking resistance. In addition, since the internal tensile stress CT can be further reduced, glass fracture can be more effectively inhibited or prevented.

As described above, the chemically strengthened glass of the present invention not only has chemically strengthened properties designed so that the front surface and the back surface differ in stress profile but also has chemically strengthened properties designed so that the edge surfaces also have a desired stress profile, for use in various applications including the cover glasses of display devices. Consequently, glass fracture due to any of various causes of cracks including cracks starting in the main surfaces and cracks starting from the edge surfaces can be more effectively inhibited or prevented, and a chemically strengthened glass having enhanced practical strength can be provided.

### (Radius of Curvature)

With respect to the chemically strengthened glasses of Examples 2 to 6 and Comparative Examples 3 to 7, the radii of curvature calculated from the respective warpage amounts are collectively shown in Table 4 and Table 6.

TABLE 3

| | | Measured values of stress | | | | | | |
|---|---|---|---|---|---|---|---|---|
| | | First | | Second | | | | |
| | | surface | | surface | | Warpage | | |
| | | CS₁ | DOL₁ | CS₂ | DOL₂ | A | ΔCS × | CT |
| | | [MPa] | [μm] | [MPa] | [μm] | [μm] | ΔDOL | [MPa] |
| Example | n1 | 437 | 40.2 | 775 | 25.5 | −90.6 | −4943.5 | 37.8 |
| 2 | n2 | 426 | 40.8 | 765 | 26.1 | −91.1 | −4971.9 | 37.8 |
| Example | n1 | 428 | 40.4 | 773 | 25.6 | 90.8 | −5126.4 | 37.6 |
| 3 | n2 | 435 | 40.9 | 767 | 26.2 | −76.8 | −4872.2 | 38.4 |
| Example | n1 | 149 | 86.7 | 726 | 24.5 | 116.0 | −35885.0 | 34.2 |
| 4 | n2 | 160 | 84.6 | 741 | 24.3 | −177.7 | −34986.2 | 35.0 |
| Example | n1 | 153 | 85.6 | 740 | 24.3 | 98.2 | −35975.2 | 34.5 |
| 5 | n2 | 153 | 85.6 | 740 | 25.4 | 70.0 | −35321.2 | 35.5 |
| Compar- | n1 | 858 | 25.5 | 855 | 25.6 | 14.7 | −0.4 | 43.0 |
| ative | n2 | 859 | 25.5 | 856 | 25.7 | −11.5 | −0.7 | 43.1 |
| Example | | | | | | | | |
| 3 | | | | | | | | |
| Compar- | n1 | 861 | 25.5 | 859 | 25.7 | −14.3 | −0.4 | 43.2 |
| ative | n2 | 861 | 25.5 | 857 | 25.7 | −18.2 | −0.8 | 43.2 |
| Example | | | | | | | | |
| 4 | | | | | | | | |

TABLE 4

| | | | | | | | | | | | Radius of |
|---|---|---|---|---|---|---|---|---|---|---|---|
| | | | | | | | | | | | curvature |
| | | | | | | | | | | [Dh_{K}(E)- | calculated |
| | | | | | | | | | | Dh_{K}(1)] × | from |
| | | | | | | | | [Dh_{K}(E)- | [Dh_{K}(E)- | [Dh_{K}(E)- | warpage |
| | | S_{K}(E) | S_{K}(1) | S_{K}(2) | Dh_{K}(E) | Dh_{K}(1) | Dh_{K}(2) | Dh_{K}(1)] | Dh_{K}(2)] | Dh_{K}(2)] | [mm] |
| Example 2 | n1 | 147287 | 110118 | 100185 | 11.282 | 11.988 | 7.877 | −0.71 | 3.40 | −2.40 | 24834 |
| | n2 | 161661 | 112225 | 115074 | 11.39 | 12.007 | 9.1135 | −0.62 | 2.28 | −1.40 | 24698 |
| Example 3 | n1 | 145841 | 107567 | 109334 | 10.121 | 11.904 | 8.4551 | −1.78 | 1.67 | −2.97 | 24780 |
| | n2 | 161528 | 116483 | 125493 | 11.041 | 12.159 | 9.6694 | −1.12 | 1.37 | −1.53 | 29297 |
| Example 4 | n1 | 216049 | 131968 | 102456 | 17.648 | 21.977 | 8.4906 | −4.33 | 9.16 | −39.65 | 19397 |
| | n2 | 209892 | 116950 | 110491 | 16.584 | 23.967 | 8.933 | −7.38 | 7.65 | −56.49 | 12662 |
| Example 5 | n1 | 183410 | 118648 | 133077 | 15.29 | 24.486 | 10.335 | −9.20 | 4.96 | −45.57 | 22912 |
| | n2 | 209297 | 149445 | 107764 | 16.542 | 21.23 | 8.4916 | −4.69 | 8.05 | −37.74 | 32143 |
| Compar- | n1 | 145258 | 109922 | 111729 | 8.8528 | 8.1152 | 8.2189 | 0.74 | 0.63 | 0.47 | 153061 |
| ative | n2 | 154691 | 106771 | 102678 | 10.002 | 7.6857 | 7.6619 | 2.32 | 2.34 | 5.42 | 195652 |
| Example 3 | | | | | | | | | | | |
| Compar- | n1 | 124801 | 109519 | 110419 | 8.3878 | 8.1129 | 8.2134 | 0.27 | 0.17 | 0.05 | 157343 |
| ative | n2 | 114700 | 111131 | 105494 | 7.7555 | 8.3173 | 7.9941 | −0.56 | −0.24 | 0.13 | 123626 |
| Example 4 | | | | | | | | | | | |

TABLE 5

| | | Measured values of stress | | | | | | |
|---|---|---|---|---|---|---|---|---|
| | | First | | Second | | | | |
| | | surface | | surface | | Warpage | | |
| | | CS₁ | DOL₁ | CS₂ | DOL₂ | A | ΔCS × | CT |
| | | [MPa] | [μm] | [MPa] | [μm] | [μm] | ΔDOL | [MPa] |
| Example 6 | n1 | 214.3 | 107.1 | 675.0 | 51.5 | 92.1 | −25592.6 | 53.3 |
| | n2 | 215.3 | 102.2 | 689.1 | 53.7 | 85.2 | −22967.2 | 54.3 |
| Compar- | n1 | 714.5 | 31.9 | 716.8 | 31.1 | 68.2 | −1.8 | 35.4 |
| ative | n2 | 695.1 | 32.2 | 703.5 | 31.6 | 48.8 | −5.2 | 35.1 |
| Example 5 | | | | | | | | |
| Compar- | n1 | 655.2 | 55.8 | 671.4 | 51.9 | 82.9 | −62.5 | 60.3 |
| ative | n2 | 660.0 | 55.6 | 679.1 | 55.8 | 112.1 | 2.7 | 63.4 |
| Example 6 | | | | | | | | |
| Compar- | n1 | 211.5 | 109.6 | 167.9 | 111.2 | 151.9 | −68.0 | 43.7 |
| ative | n2 | 180.0 | 103.8 | 204.2 | 110.6 | 111.0 | 165.6 | 42.5 |
| Example 7 | | | | | | | | |

TABLE 6

| | | | | | | | | | | | Radius of |
|---|---|---|---|---|---|---|---|---|---|---|---|
| | | | | | | | | | | | curvature |
| | | | | | | | | | | [Dh_{K}(E)-Dh_{K}(1)] | calculated from |
| | | | | | | | | | | × | warpage |
| | | S_{K}(E) | S_{K}(1) | S_{K}(2) | Dh_{K}(E) | Dh_{K}(1) | Dh_{K}(2) | [Dh_{K}(E)-Dh_{K}(1)] | [Dh_{K}(E)-Dh_{K}(2)] | [Dh_{K}(E)-Dh_{K}(2)] | [mm] |
| Example 6 | n1 | 389344 | 369339 | 363030 | 30.825 | 35.495 | 29.408 | −4.67 | 1.42 | −6.62 | 24430 |
| | n2 | 403294 | 363379 | 359126 | 30.847 | 35.897 | 28.889 | −5.05 | 1.96 | −9.89 | 26408 |
| Comparative | n1 | 340067 | 330475 | 335649 | 28.932 | 30.336 | 30.15 | −1.40 | −1.22 | 1.71 | 32991 |
| Example 5 | | | | | | | | | | | |
| Comparative | n1 | 400897 | 397972 | 402934 | 29.771 | 28.397 | 28.556 | 1.37 | 1.21 | 1.67 | 27141 |
| Example 6 | | | | | | | | | | | |
| Comparative | n1 | 411220 | 387953 | 390105 | 35.697 | 35.125 | 35.342 | 0.57 | 0.36 | 0.20 | 14812 |
| Example 7 | | | | | | | | | | | |

TABLE 7

| | Cracking height, cm | | |
|---|---|---|---|
| | (average value, n = 15) | | |
| | G80 SP | G120 SP | Asphalt |
| Example 6 | 128.3 | 188.0 | 87.7 |
| Comparative | 52.8 | 95.3 | 67.2 |
| Example 5 | | | |
| Comparative | 29.8 | 145.8 | 68.8 |
| Example 6 | | | |
| Comparative | 112.5 | 166.0 | 49.2 |
| Example 7 | | | |

The present application is based on Japanese Patent Application No. 2016-034478 filed on Feb. 25, 2016, and the contents are incorporated herein by reference.

### DESCRIPTION OF REFERENCE NUMERALS AND SIGNS

1 Glass substrate
A Maximum warpage

What is claimed is:

1. A chemically strengthened glass having a first surface and a second surface which faces the first surface,
wherein the first surface has a depth of compressive stress layer DOL₁ (μm) which is larger by at least 3 μm than a depth of compressive stress layer DOL₂ (μm) of the second surface,
the second surface has a surface compressive stress CS₂ (MPa) which is higher by at least 50 MPa than a surface compressive stress CS₁ (MPa) of the first surface, and
the chemically strengthened glass satisfies the following relational expressions (2) and (3):
[Dh(E)−Dh(1)]<0 (2)
[Dh(E)−Dh(2)]>0 (3)
in which Dh(E) is a depth at which, when an edge surface of the chemically strengthened glass is examined with an EPMA, an integral of replacing-ion X-ray intensity from an outermost surface of the edge surface becomes S(E)/2, where S(E) is an integral of replacing-ion X-ray intensity from the outermost surface of the edge surface to a depth of 80 μm,
Dh(1) is a depth at which, when the first surface of the chemically strengthened glass is examined with an EPMA, an integral of replacing-ion X-ray intensity from an outermost surface of the first surface becomes S(1)/2, where S(1) is an integral of replacing-ion X-ray intensity from the outermost surface of the first surface to a depth of 80 μm, and
Dh(2) is a depth at which, when the second surface of the chemically strengthened glass is examined with an EPMA, an integral of replacing-ion X-ray intensity from an outermost surface of the second surface becomes S(2)/2, where S(2) is an integral of replacing-ion X-ray intensity from the outermost surface of the second surface to a depth of 80 μm.

2. The chemically strengthened glass according to claim 1, which satisfies the following relational expression (1):
(CS₁−CS₂)×(DOL₁−DOL₂)<−1,500 (1).

3. The chemically strengthened glass according to claim 1, wherein the depth of compressive stress layer DOL₁ (μm) of the first surface is 15 μm or larger.

4. The chemically strengthened glass according to claim 1, wherein the surface compressive stress CS₁ (MPa) of the first surface is 100 MPa or higher.

5. The chemically strengthened glass according to claim 1, wherein the depth of compressive stress layer DOL₂ (μm) of the second surface is 5 μm or larger.

6. The chemically strengthened glass according to claim 1, wherein the surface compressive stress CS₂ (MPa) of the second surface is 500 MPa or higher.

7. The chemically strengthened glass according to claim 1, which has a radius of curvature of 15,000 mm or larger.

8. The chemically strengthened glass according to claim 1, which has a radius of curvature of less than 15,000 mm.

9. The chemically strengthened glass according to claim 1, which is obtained by chemically strengthening a curved-surface glass substrate.
